(19) United States
(12) Patent Application Publication
(10) Pub. No.: US 2014/0029372 A1
(43) Pub. Date: Jan. 30, 2014

(54) Auto Stucco Trowel

(71) Applicant: Tony Marion Roark, Jr., Abingdon, VA (US)

(72) Inventor: Tony Marion Roark, Jr., Abingdon, VA (US)

(21) Appl. No.: 13/954,134

(22) Filed: Jul. 30, 2013

Related U.S. Application Data
(60) Provisional application No. 61/677,312, filed on Jul. 30, 2012.

(51) Int. Cl. B28C 5/08

(52) U.S. Cl. CPC B28C 5/0806
USPC 366/51

(57) ABSTRACT

An apparatus for mixing and delivering a liquefied masonry mix such as grout, mortar, stucco, and the like is presented. The apparatus comprises a frame element, a hopper element, and a dispensing element. A bag of masonry mix may be loaded into the hopper element, mixed with water, and dispensed as a liquid mix through a hose with an attachable dispensing tool such as a trowel to a point of application such as a wall surface.

### CROSS-REFERENCE

This application claims priority from Provisional Patent Application Ser. No. 61/677,312 filed Jul. 30, 2012.

### FIELD OF THE INVENTION

This invention pertains generally to an apparatus for mixing and delivering grout or stucco, and more particularly to an apparatus for mixing a masonry compound with water and pumping it through a hose to a variety of interchangeable dispensing tool attachments.

### BACKGROUND

Applying stucco to an exterior of a home, or grouting between bricks and concrete blocks is a time consuming task. A worker must first mix a solid cement based material with water in a container. Mixing cement by hand with a shovel or rake is a laborious and tedious process. Then the mixing container must be transported to the job site for application of the liquid grout or stucco. The worker will typically dip a hand into the container and remove a small portion of the grout or stucco. Excess material may stick to the user's hands and arms complicating the task. Finally, the worker may then apply the grout or stucco to the desired surface. Once the limited supply of grout or stucco is applied, the user must return to the container and remove another small amount of product. The process continues until all of the product hardens or is used up.

Consequently, there exists a need for a device designed to automatically mix and deliver grout, stucco, and similar materials to a surface for use. The present invention discloses a portable device for automatically mixing bags of grout, cement, mortar mix, and the like, with water to create a liquid or semi-liquid cement-based product. The device may then pump the liquid product to one of a plurality of attachments for application to a surface or void such as a wall requiring an application of stucco or a wall requiring mortar between the joints. The invention is self contained and does not require an outside power source such as an electrical outlet. Furthermore, the invention is adaptable to apply water, paints, liquid finishes, or even air under pressure.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a masonry compound delivery apparatus. The masonry delivery apparatus comprises a frame element, a hopper element, a dispensing element, and at least one motor. A bag of grout, cement, or similar product is placed within the hopper element and is mixed with water by the at least one motor. Once liquefied, the product is then pumped through a hose in the dispensing element to a plurality of attachments for final application to a surface or a void space. The plurality of attachments connect to the hose via a quick connect coupling. A rate of flow of the product is controlled by a regulator switch located on either the hose or the plurality of attachments.

Furthermore, in a preferred embodiment of the invention, the at least one motor comprises a first and a second motor. The first motor may be used to turn a plurality of blades within the hopper element. The second motor is used to create air pressure to pump the product through the hose. The rate of flow may be started, increased, or decreased by the pressure switch, such as a spring operated hand lever or a button on the plurality of attachments. Furthermore, the plurality of attachments may comprise attachments for other uses than the delivery and application of a masonry compound, such as but not limited to paint, water, a liquid finish, air, and the like.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a masonry compound delivery apparatus in accordance with the disclosed architecture.

FIG. 2 illustrates a perspective view of the masonry compound delivery apparatus in accordance with the disclosed architecture.

FIG. 3 illustrates an overhead view of the masonry compound delivery apparatus in accordance with the disclosed architecture.

FIG. 4 illustrates a cutaway view of the masonry compound delivery apparatus in accordance with the disclosed architecture.

FIG. 5 illustrates an exploded view of a dispensing element of the masonry compound delivery apparatus in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

The present invention discloses a mortar delivery apparatus for automatically mixing and delivering a liquefied grout or stucco compound to a tool for application to a surface or to fill a void. The mortar delivery apparatus comprises a hopper element for combining a bag of masonry mix with water. The mortar delivery apparatus further comprises a dispensing element comprising a hose and a plurality of dispensing tools that are attachable to the hose. A rate of flow of a liquefied masonry mix is controlled via a regulator located on the dispensing element.

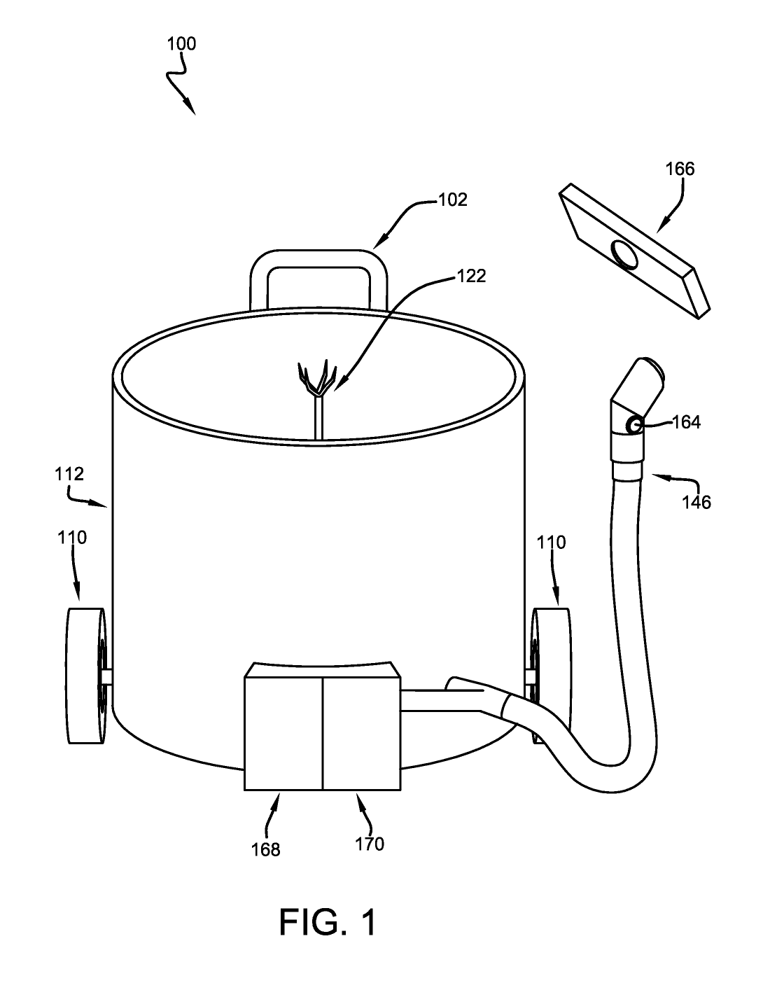

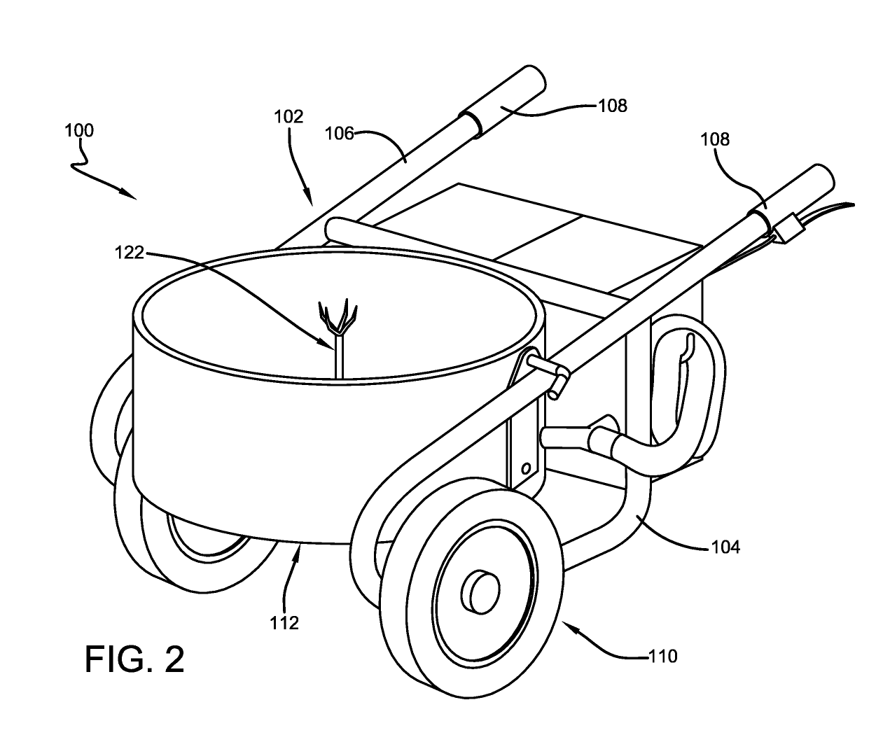

Referring initially to the drawings, FIGS. 1 and 2 illustrate a mortar delivery apparatus 100 for use with a bag of masonry mix. The bag of masonry mix is typically a bag of building material mix such as, but not limited to concrete mix, stucco mix, grout mix, plaster mix, drywall compound, and the like. The mortar delivery apparatus 100 comprises a frame element 102, a hopper element 112, a dispensing element 146, and at least a first motor 168. The bag of masonry mix is placed into the hopper element 112 and is mixed with water to form a liquid or semi-liquid product for applying to a surface or into a void.

The frame element 102 comprises a support structure 104 and at least one wheel 110. The support structure 104 is typically constructed from a framework 106 of plastic or metal tubing, ribs, rods, bars, and the like for surrounding the hopper element 112 and attaching it to the at least one wheel 110. The support structure 104 comprises a pair of handles 108 to allow the user to push and steer the mortar delivery apparatus 100 around a job site. For example, as illustrated in FIG. 2, the support structure 104 may be a plurality of curved rods terminating in the pair of handles 108 that curve down towards the at least one wheel 110. Then the support structure 104 may act as a support stand when the mortar delivery apparatus 100 is not in use. The support structure 104 may also resemble a dolly (not shown) or any other type of framework desirable. When the pair of handles 108 are lifted, the framework 106 is raised so that the mortar delivery apparatus 100 may be moved via the at least one wheel 110. Preferable the at least one wheel 110 is a pair of wheels for increased stability. Furthermore, the at least one wheel 110 may be self propelled by the at least a first motor 168.

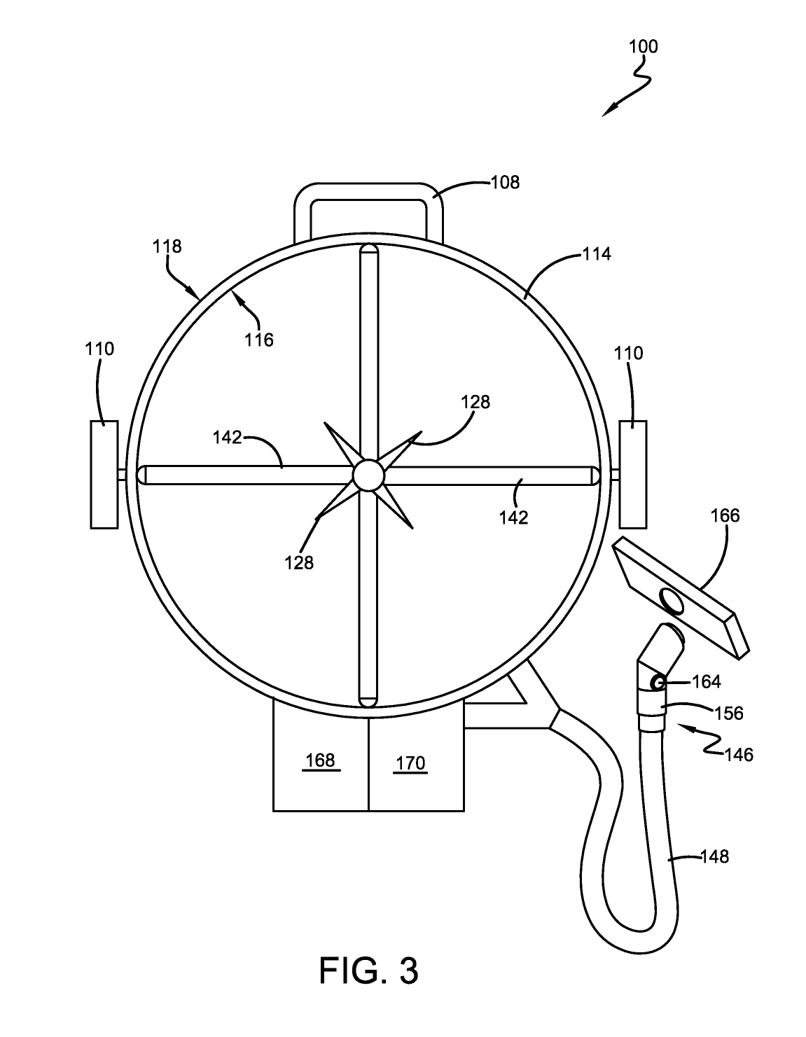

As illustrated in FIGS. 1-3, the hopper element 112 comprises a container 114 that is typically a metal or plastic bucket similar to a wheel barrow tray or storage hopper. The container 114 comprises an interior 116, an exterior 118, and a bottom 120. The container 114 is typically between approximately two and three feet in diameter, and between approximately three and four feet in height. However, the dimensions may be larger or smaller as desired and of any shape desired as well. The dimensions are typically large enough to hold at least one cubic feet of material. The container 114 will hold the contents of the bag of masonry mix and enough water to liquefy the masonry mix.

The hopper element 112 further comprises a piercing component 122 comprising a shaft 124 located substantially within the container 114. The shaft 124 typically extends up from the bottom 120 of the container at approximately a center of the diameter of the container 114 where it is rotatably connected to the first motor 168. The piercing component 122 either terminates in a spike or a plurality of prongs 128 for piercing the bag of masonry mix. The piercing component 122 further comprises a shelf rest 130 located on an upper half of the shaft 124. The shelf rest 130 may be a circular plate or a plurality of rods extending substantially perpendicularly from the shaft 124. Alternatively, the shelf rest 130 may comprise a rim 9 not shown) located along the interior 116 of the container 114.

The hopper element 112 further comprises a shelf component 132. The shelf component 132 is typically a metal or plastic grating dimensioned to fit within the diameter of the container 114. As such, the shelf component 132 may be circular, rectangular, square, or any other shape desirable. The shelf component 132 comprises a pair of handles 134 and a center opening 136. The center opening 136 must be large enough so that the shelf component 132 can slide over the shaft 124 and the plurality of prongs 128 of the piercing component 122. Once in place over the shaft 124, the shelf component 132 will rest on the shelf rest 130.

The user may either first place the shelf component 132 on the shelf rest 130 and then place the bag of masonry mix on the shelf component 132, or may load the bag of masonry mix onto the shelf component 132 prior to placing it on the shelf rest 130. As the bag of masonry mix enters the container 114, either the spike or the plurality of prongs 128 pierce the bag of masonry mix. The user may then grab one of the pair of handles 134 and rotate the shelf component 132 around the shaft 124 within the container 114, thereby enlarging the opening in the bag of masonry mix so that the contents of the bag of masonry mix fall through the shelf component 132 and into the bottom 120 of the container 114. The shelf component 132 and empty bag may then be removed.

The hopper element 112 further comprises a mixing component 138. The mixing component 138 comprises a sleeve 140 and a plurality of blades 142 extending out of the sleeve 140. The sleeve 140 surrounds the shaft 124 of the piercing component 122 at a level below that of the shelf rest 130. The plurality of blades 142 are typically mixing paddles that may be solid, perforated, grated, rubber lined, or the like. The plurality of blades 142 extend outward from the shaft 124. Additionally, the plurality of blades 142 may be angled up to 45 degrees from the horizontal to improve mixing. The plurality of blades 142 may also curve at an end of each blade so that the interior 116 of the container 114 may be scraped clean for better mixing. The plurality of blades 142 are rotated by the first motor 168 and are used to combine the contents of the bag of masonry mix with water to produce a liquid or semi-liquid compound for application.

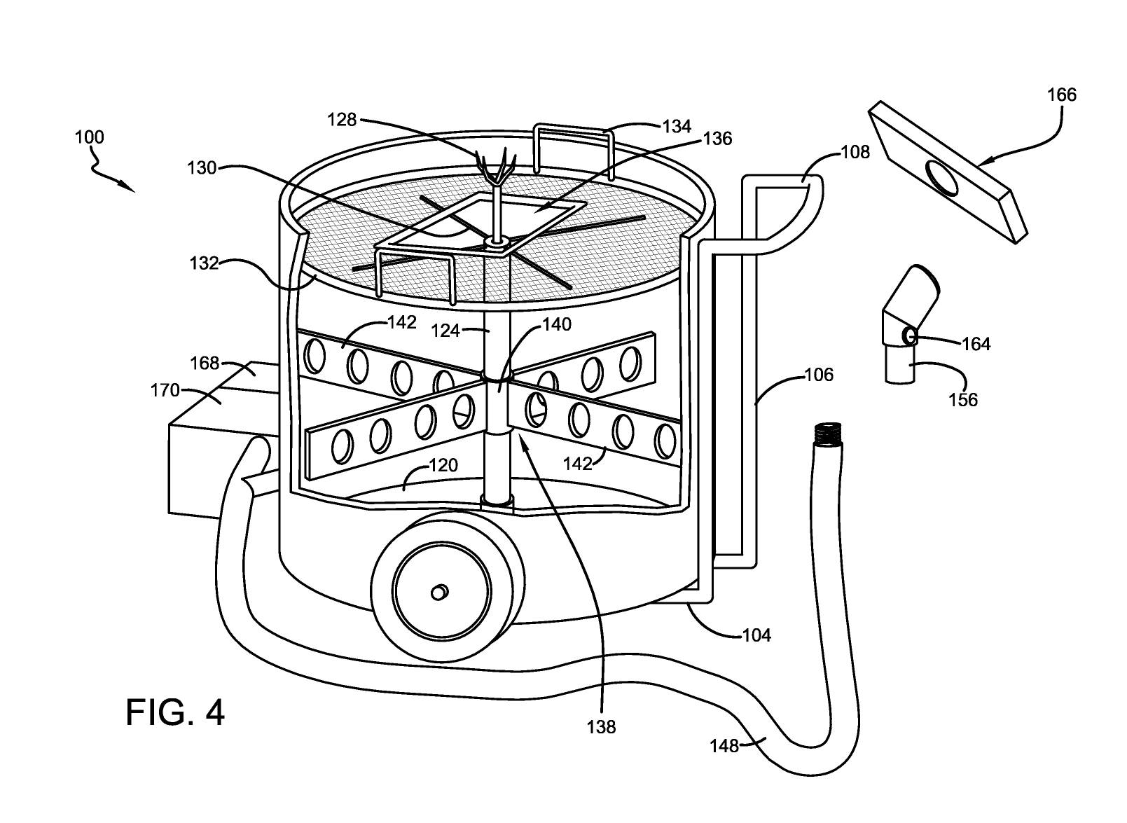

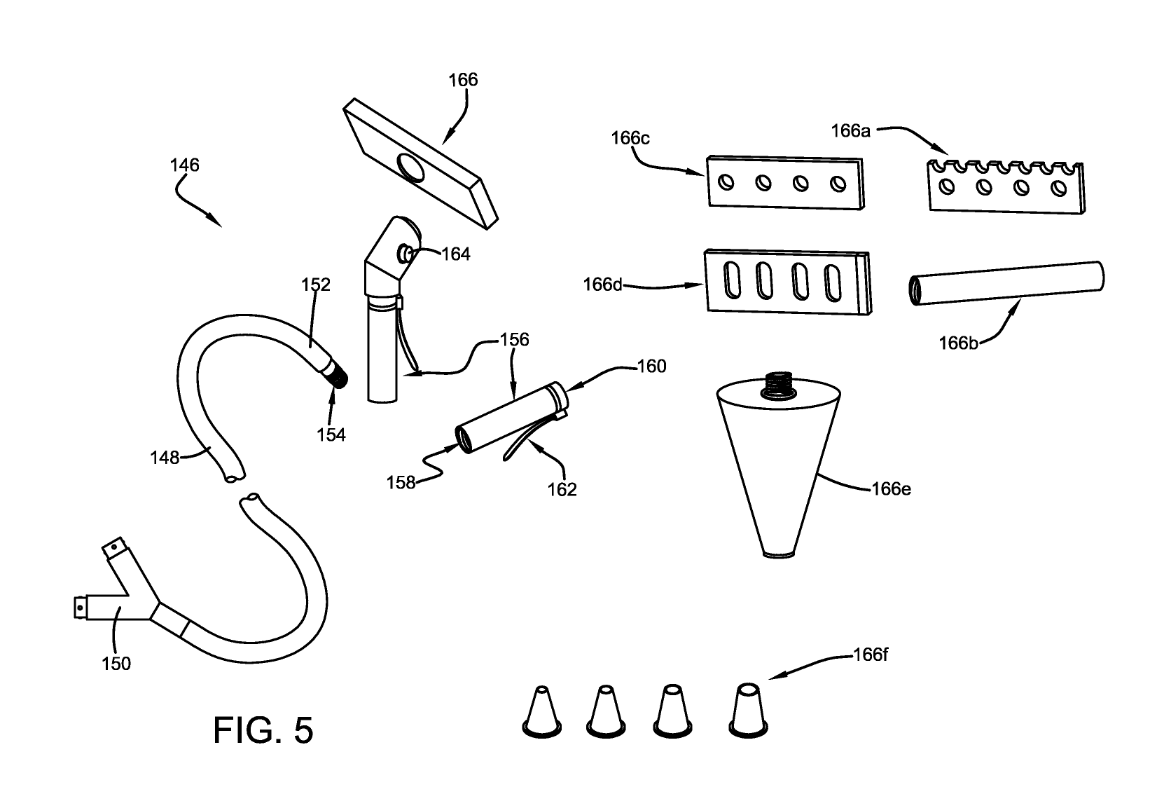

As illustrated in FIGS. 4-5, the dispensing element 146 comprises a hose 148, a handle element 156, and a plurality of dispensing tools 166. Preferably, the masonry compound delivery apparatus 100 further comprises a second motor 170 for controlling the dispensing element 146. Alternatively, the first motor 168 may power both the mixing component 138 and the dispensing component 146. The hose 148 is typically approximately between ⅜ and one inches in diameter and may be between 10 and 60 feet in length. The hose 148 comprises a first end 150 which connects to an opening (not shown) through the exterior 118 toward or out of the bottom 120 of the container 114. The first end 150 is typically bifurcated so that it may also connect directly to the second motor 170. The hose 150 further comprises a second end 152. The second end 152 typically comprises a threaded connection 154, although it is contemplated that it may also comprise a quick connect, a snap connect, or any other connection known to one of skill in the art.

The handle element 156 is a universal handle for connecting the hose 148 to each of the plurality of dispensing tools 166. The handle element 156 comprises a threaded opening 158 for engaging with the threaded connection 154 of the hose 148. Alternatively, the handle element 156 may comprise a quick connect, a snap connect, or any other connector suitable to connect to the second end 152 of the hose 148. The handle element 156 further comprises a regulator 162. The regulator 162 is typically a spring activated handle lever, air pressure operated lever, push button, slide, or the like. The regulator 162 allows the user to control a rate of flow of the liquefied product through the hose 148. The handle element 156 further comprises a quick connect coupling 160 for connecting to one of the plurality of dispensing tools 166. Alternatively, the regulator 162 for controlling the flow of liquefied product may comprise a push button controller 164 for use as the regulator 162 and may be located on either the handle element 156 or any of the plurality of dispensing tools 166.

The handle element 156 further comprises an internal valve (not shown). The internal valve is typically a flow regulating valve, such as but not limited to, a check valve, a spring operated valve, a flapper valve, a swing check valve, a tilting disc valve, a stop check valve, a lift check valve, a butterfly valve, a gated valve, a ball valve, and the like, or any other valve for regulating a flow of a liquid. The regulator 162 operates the internal valve. Additionally, the regulator 162 may be battery powered alleviating the need for an external electrical power source. Furthermore, the regulator 162 may be in wireless communication with the second motor 170 to control the flow of liquefied product.

The plurality of dispensing tools 166 may comprise a trowel 166(a), an extension rod 166(b), a float 166(c), a hawk 166(d), a grout bag 166(e) with grout bag tips 166(f), a spinning handle (not shown), and a sprayer (not shown). Many of the plurality of dispensing tools 166 are designed to speed up the application of the masonry compound. The trowel 166(a) may comprise a notched trowel, a smooth edge trowel, an edging trowel, or any other trowel used to apply stucco, grout, and the like.

While the masonry compound delivery apparatus 100 is preferably used to mix and deliver a building material mix as discussed supra, it has additional uses. The spinning handle converts the masonry compound delivery apparatus 100 into a drill for use with a variety of drilling or spinning attachments (not shown). The sprayer attachment may be used to apply a liquid paint or stain similar to a paint spray gun or automatic paint roller. Furthermore, the sprayer attachment may allow the masonry compound delivery apparatus 100 to be used as a pressure washer or compressed air gun. In these applications, only water or paint would be added to the container 114. It is also possible, to reverse the direction of flow in the hose 148 to create a vacuum.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A masonry compound delivery apparatus for mixing and dispensing a material comprising:
a frame element comprising a support structure and at least one wheel attached to the support structure;
a hopper element attached to the support structure comprising a container, a piercing component within the container, a shelf component attachable to the piercing component, and a mixing component attachable to the piercing component, and
a dispensing element in fluid communication with the container comprising a hose and at least one dispensing tool attachable to the hose, and
at least one motor for pumping the liquid material through the dispensing element.

2. The masonry compound delivery apparatus of claim 1, wherein the liquid material is grout, stucco, plaster, mortar, drywall compound, paint, or water.

3. The masonry compound delivery apparatus of claim 1, wherein the piercing component is a shaft terminating in a spike.

4. The masonry compound delivery apparatus of claim 1, wherein the piercing component is a shaft terminating in a plurality of prongs.

5. The masonry compound delivery apparatus of claim 4, wherein the piercing component is rotatable within the container.

6. The masonry compound delivery apparatus of claim 1, wherein the mixing component comprises a plurality of paddle blades.

7. A masonry compound delivery apparatus for mixing and dispensing a liquid material comprising:
a frame element comprising a support structure and at least one wheel attached to the support structure;
a hopper element attached to the support structure comprising a container, a piercing component within the container, a shelf component attachable to the piercing component, and a mixing component attachable to the piercing component; and
a dispensing element in fluid communication with the container comprising a hose, a handle element attachable to the hose comprising a regulator for controlling a flow of the liquid through the dispensing element, and a plurality of dispensing tools attachable to the handle element; and
a first motor for controlling the mixing component and a second motor for pumping the liquid material through the dispensing element.

8. The masonry compound delivery apparatus of claim 7, wherein the piercing component is a rotatable shaft terminating in a plurality of prongs.

9. The masonry compound delivery apparatus of claim 7, wherein the plurality of dispensing tools are attachable to the handle element via a quick connect coupling.

10. The masonry compound delivery apparatus of claim 7, wherein the mixing component comprises a plurality of perforated paddle blades.

11. The masonry compound delivery apparatus of claim 7, wherein the plurality of dispensing tools comprise at least one of the following attachments: an extension rod, a spray wand, a masonry dispensing tip, a notched trowel, a smooth trowel, an edger trowel, a float trowel, a grout bag, and a masonry hawk.

12. The masonry compound delivery apparatus of claim 7, wherein the handle element further comprises a valve operated by the regulator.

13. The masonry compound delivery apparatus of claim 12, wherein the valve comprises at least one of the following valves: a flapper valve, a swing check valve, a tilting disc check valve, a stop check valve, a lift check valve, or a butterfly valve.

14. A masonry compound delivery apparatus for mixing and dispensing a liquid material comprising:
a frame element comprising a support structure and a plurality of wheels attached to the support structure;
a hopper element attached to the support structure comprising a container, a piercing component within the container, a shelf component attachable to the piercing component, and a mixing component attachable to the piercing component; and
a dispensing element in fluid communication with the container comprising a hose, a handle element attachable to the hose comprising a spring activated flapper valve and a regulator for operating the spring activated flapper valve, and a plurality of dispensing tools attachable to the handle element; and
a first motor in electrical communication with the mixing component and a second motor in electrical communication with the dispensing element.

15. The masonry compound delivery apparatus of claim 14, wherein the piercing component is a rotatable shaft terminating in a plurality of prongs.

16. The masonry compound delivery apparatus of claim 14, wherein the plurality of dispensing tools comprise at least one of the following attachments: an extension rod, a spray wand, a masonry dispensing tip, a notched trowel, a smooth trowel, a grout bag, and a masonry hawk.

17. The masonry compound delivery apparatus of claim 14, wherein the plurality of dispensing tools comprises a spinning handle.

18. The masonry compound delivery apparatus of claim 17, wherein the spinning handle comprises a plurality of drill attachments.

19. The masonry compound delivery apparatus of claim 14, wherein the plurality of dispensing tools comprises a pressure washing nozzle.

20. The masonry compound delivery apparatus of claim 14, wherein the second motor is reversible to create a vacuum in the hose.
